(19) United States
(12) Patent Application Publication
(10) Pub. No.: US 2018/0021608 A1
(43) Pub. Date: Jan. 25, 2018

(54) Filtering Face-Piece Respirator And Method Of Forming Same

(71) Applicant: 3M INNOVATIVE PROPERTIES COMPANY, St. Paul, MN (US)

(72) Inventors: Xiaoping Zhou, JiangSu (CN); Tian Tian, Shanghai (CN); Hans Yin, Shanghai (CN); Fan Yang, Shanghai (CN); Mingming Wang, Shanghai (CN)

(21) Appl. No.: 15/547,543

(22) PCT Filed: Feb. 9, 2015
(86) PCT No.: PCT/CN2015/072574

§ 371 Date: Jul. 31, 2017

(51) Int. Cl. A62B 23/02; A41D 13/11

(52) U.S. Cl. CPC A62B 23/025; A41D 13/113; A41D 13/1161; A41D 13/1146; A41D 2500/30

(57) ABSTRACT

Various embodiments of a filtering face-piece respirator and a method of forming such respirator are disclosed. In one or more embodiments, the filtering face-piece respirator can include a mask body. The mask body can include an inner cover web, an outer cover web, and filter media enclosed between the inner cover web and outer cover web such that the filter media does not extend to an edge of the mask body.

### BACKGROUND

Respirators are commonly worn over a person's breathing passages in at least one of two situations: (1) to prevent impurities or contaminants from entering the wearer's respiratory system; and (2) to protect other persons or things from being exposed to pathogens and other contaminants exhaled by the wearer. In the first situation, the respirator is worn in an environment where the air contains particles that may be harmful to the wearer, for example, in an auto body shop. In the second situation, the respirator is worn in an environment where there is risk of contamination to other persons or things, for example, in an operating room or clean room.

A variety of respirators have been designed to be used in one or both of these situations. Some of these respirators have been categorized as being “filtering face-pieces” because the mask body itself functions as the filtering mechanism. Unlike respirators that use rubber or elastomeric mask bodies with attachable filter cartridges (see, e.g., U.S. Pat. No. RE39,493 to Yuschak et al.) or insert-molded filter elements (see, e.g., U.S. Pat. No. 4,790,306 to Braun et al.), filtering face-piece respirators are designed to have the filter media cover much of the mask body so that there is no need for installing or replacing a filter cartridge. These filtering face-piece respirators commonly come in one of two configurations: molded respirators and flat-fold respirators.

Molded filtering face-piece respirators often include non-woven webs of thermally-bonded fibers or open-work plastic meshes to furnish the mask body with its cup-shaped configuration. Molded respirators tend to maintain the same shape during both use and storage. These respirators, therefore, cannot be folded flat for storage and shipping. Examples of patents that disclose molded, filtering, face-piece respirators include U.S. Pat. No. 7,131,442 to Kronzer et al; U.S. Pat. Nos. 6,923,182 and 6,041,782 to Angadjivand et al.; U.S. Pat. No. 4,807,619 to Dyrud et al.; and U.S. Pat. No. 4,536,440 to Berg.

Flat-fold respirators, as the name implies, can be folded flat for shipping and storage. Such respirators can be opened into a cup-shaped configuration for use. Examples of flat-fold respirators are described in U.S. Pat. Nos. 6,568,392 and 6,484,722 to Bostock et al.; and U.S. Pat. No. 6,394,090 to Chen et al. Some flat-fold respirators have been designed with weld lines, seams, and folds to help maintain their cup-shaped configurations during use. Stiffening members have also been incorporated into panels of the mask body. See, e.g., U.S. Patent Publication Nos. 2011/0067700 and 2010/0154805 to Duffy et al.; and U.S. Design Pat. No. 659,821 to Spoo et al.

Flat-fold respirators have two general orientations when folded flat for storage. In one configuration—sometimes referred to as a “horizontal” flat-fold respirator—the mask body is folded crosswise such that it has an upper portion and a lower portion. A second type of respirator is referred to as a “vertical” flat-fold respirator because the primary fold is oriented vertically when the respirator is viewed from the front in an upright position. Vertical flat-fold respirators have left and right portions on opposing sides of the vertical fold or a centerline of the mask body.

### SUMMARY

In general, the present disclosure provides various embodiments of a filtering face-piece respirator and a method of forming the filtering face-piece respirator. In one or more embodiments, the respirator can include a mask body that includes a filter media enclosed between an inner cover web and an outer cover web such that the filter media does not extend to an edge of the mask body.

In one aspect, the present disclosure provides a filtering face-piece respirator that includes a mask body. The mask body includes an inner cover web, an outer cover web, and filter media disposed between the inner cover web and outer cover web in a filter region of the mask body. The mask body also includes a seal region that defines at least a portion of a perimeter of the mask body, where the inner cover web is attached to the outer cover web in the seal region, and further where the filter media does not extend into at least a portion of the seal region.

In another aspect, the present disclosure provides a filtering face-piece respirator that includes a mask body. The mask body includes an inner cover web, an outer cover web, and filter media enclosed between the inner cover web and outer cover web such that the filter media does not extend to an edge of the mask body.

In another aspect, the present disclosure provides a method of forming a filtering face-piece respirator that includes a mask body. The method includes forming filter media, attaching the filter media to an inner cover web, and attaching the inner cover web to an outer cover web to form a seal region that defines a perimeter of the mask body. The filter media is disposed between the inner cover web and the outer cover web, and the filter media does not extend into at least a portion of the seal region.

All headings provided herein are for the convenience of the reader and should not be used to limit the meaning of any text that follows the heading, unless so specified.

The terms “comprises” and variations thereof do not have a limiting meaning where these terms appear in the description and claims. Such terms will be understood to imply the inclusion of a stated step or element or group of steps or elements but not the exclusion of any other step or element or group of steps or elements.

The words “preferred” and “preferably” refer to embodiments of the disclosure that may afford certain benefits, under certain circumstances; however, other embodiments may also be preferred, under the same or other circumstances. Furthermore, the recitation of one or more preferred embodiments does not imply that other embodiments are not useful, and is not intended to exclude other embodiments from the scope of the disclosure.

In this application, terms such as “a,” “an,” and “the” are not intended to refer to only a singular entity, but include the general class of which a specific example may be used for illustration. The terms “a,” “an,” and “the” are used interchangeably with the term “at least one.” The phrases “at least one of” and “comprises at least one of” followed by a list refers to any one of the items in the list and any combination of two or more items in the list.

The phrases “at least one of” and “comprises at least one of” followed by a list refers to any one of the items in the list and any combination of two or more items in the list.

As used herein, the term “or” is generally employed in its usual sense including “and/or” unless the content clearly dictates otherwise. The use of the term “and/or” in certain portions of this disclosure is not intended to mean that the use of “or” in other portions cannot mean “and/or.”

The term “and/or” means one or all of the listed elements or a combination of any two or more of the listed elements.

As used herein in connection with a measured quantity, the term “about” refers to that variation in the measured quantity as would be expected by the skilled artisan making the measurement and exercising a level of care commensurate with the objective of the measurement and the precision of the measuring equipment used. Herein, “up to” a number (e.g., up to 50) includes the number (e.g., 50).

Also herein, the recitations of numerical ranges by endpoints include all numbers subsumed within that range as well as the endpoints (e.g., 1 to 5 includes 1, 1.5, 2, 2.75, 3, 3.80, 4, 5, etc.).

### Glossary

The terms set forth herein will have the meanings as defined:

“adjacent an upper perimeter segment” means that an element or device is disposed closer to at least a portion of an upper perimeter segment of a perimeter of a mask body than to a central panel, region, or portion of the mask body;

“breathable region” means a region of the respirator that permits a transport of air from the exterior gas space to the interior gas space and vice versa;

“clean air” means a volume of atmospheric ambient air that has been filtered to remove contaminants;

“contaminants” means particles (including dusts, mists, and fumes) and/or other substances that generally may not be considered to be particles (e.g., organic vapors, etc.) but which may be suspended in air;

“crosswise dimension” is the dimension that extends laterally across the respirator, from side-to-side when the respirator is viewed from the front;

“cup-shaped configuration” and variations thereof mean any vessel-type shape that is capable of adequately covering the nose and mouth of a wearer;

“elastic” in reference to a strap of a harness or earloop means being able to be stretched at least 100% and return essentially to the original dimension without imparting damage to the strap;

“exterior gas space” means the ambient atmospheric gas space into which exhaled gas enters after passing through and beyond the mask body and/or exhalation valve;

“exterior surface” means the surface of the mask body exposed to ambient atmospheric gas space when the mask body is positioned on the wearer's face;

“face seal” means a part(s) located between the mask body and a wearer's face at one or more locations where the mask body would otherwise contact the face;

“filtering face-piece” means that the mask body itself is designed to filter air that passes through it; there are no separately identifiable filter cartridges or insert-molded filter elements attached to or molded into the mask body to achieve this purpose;

“filter” or “filtration layer” means one or more layers of air-permeable material, which layer(s) is adapted for the primary purpose of removing contaminants (such as particles) from an air stream that passes through it;

“filter media” means an air-permeable structure that is designed to remove contaminants from air that passes through it;

“filtering structure” means a generally air-permeable construction that filters air;

“flat configuration” means the respirator is folded along the centerline such that it is flat as shown in FIG. 1;

“flat-fold” means that the respirator can be folded flat for storage and opened for use;

“folded inwardly” means being bent back towards the part from which it extends;

“harness” means a structure or combination of parts that assists in supporting the mask body on a wearer's face;

“integral” means being manufactured together at the same time i.e., being made together as one part and not two separately manufactured parts that are subsequently joined together;

“interior gas space” means the space between a mask body and a wearer's face;

“interior surface” means the surface of the mask body closest to a wearer's face when the mask body is positioned on the wearer's face;

“joined to” means secured to directly or indirectly;

“line of demarcation” means a fold, seam, weld line, bond line, stitch line, hinge line, and/or any combination thereof;

“mask body” means an air-permeable structure that is designed to fit over the nose and mouth of a wearer and that helps define an interior gas space separated from an exterior gas space (including the seams and bonds that join layers and parts thereof together);

“nose clip” means a mechanical device (other than a nose foam), which device is adapted for use on a mask body to improve the seal at least around a wearer's nose;

“nose region” means the portion of the mask body that resides over a wearer's nose when the respirator is worn;

“perimeter” means the outer edge of the mask body, which outer edge would be disposed generally proximate a wearer's face when the respirator is being donned by a person; a “perimeter segment” is a portion of the perimeter;

“pleat” means a portion that is designed to be or is folded back upon itself;

“polymeric” and “plastic” each means a material that mainly includes one or more polymers and that may contain other ingredients as well;

“respirator” means an air filtration device that is worn by a person to provide the wearer with clean air to breathe;

“side” means an area on the mask body distanced from a plane that bisects the mask body centrally and vertically when the mask body is oriented in an upright position and viewed from the front;

“sinus region” means the nose region and parts or areas of the mask body that reside beneath the wearer's eyes and/or eye orbitals when the respirator is being worn in a proper configuration;

“snug fit” or “fit snugly” means that an essentially air-tight (or substantially leak-free) fit is provided (between the mask body and the wearer's face);

“strap” means a generally flat elongated structure;

“transversely extending” means extending generally in the crosswise dimension; and

“vertical flat-fold respirator” means a respirator having a primary fold that is oriented vertically when the mask is viewed from the front in an upright position.

These and other aspects of the present disclosure will be apparent from the detailed description below. In no event, however, should the above summaries be construed as limitations on the claimed subject matter, which subject matter is defined solely by the attached claims, as may be amended during prosecution.

### BRIEF DESCRIPTION OF THE DRAWINGS

Throughout the specification, reference is made to the appended drawings, where like reference numerals designate like elements, and wherein:

FIG. 1 is a schematic right side view of one embodiment of a filtering face-piece respirator.

FIG. 2 is a schematic front view of the filtering face-piece respirator of FIG. 1.

FIG. 3 is a schematic rear view of the filtering face-piece respirator FIG. 1.

FIG. 4 is a schematic cross-section view of a portion of a mask body of the filtering face-piece respirator FIG. 1.

### DETAILED DESCRIPTION

In general, the present disclosure provides various embodiments of a filtering face-piece respirator and a method of forming the filtering face-piece respirator. In one or more embodiments, the respirator can include a mask body that includes a filter media enclosed between an inner cover web and an outer cover web such that the filter media does not extend to an edge of the mask body. Any suitable filtering face-piece respirator can include filter media that does not extend to the edge of the mask body as is further described herein.

In one or more embodiments, the filter media can include a carbon layer as is also further described herein. Existing respirators that include carbon layers can in some circumstances allow carbon particles from the carbon layer to leak out of the edges of a mask body of the respirator. Such leakage can be caused, e.g., by weak or incomplete welds between cover webs and the carbon layer at the edge of the mask body. For example, welds formed by ultrasonic welding of various layers of the respirator may not seal the edge of the mask body of the respirator if, for example, the layers have differing melting points. Further, for example, carbon particles can have a melting point that is different from a melting point of the web. This difference in melting points can cause weak welds along the edge of the mask, thereby allowing carbon particles to leak from the respirator.

In one or more embodiments of the present disclosure, filter media that can include, e.g., a carbon layer can be enclosed between inner and outer cover webs such that the carbon layer does not extend to the edge of the mask body. In one or more embodiments, this entrapment of the carbon layer can prevent leakage of the carbon particles of the carbon layer from the respirator.

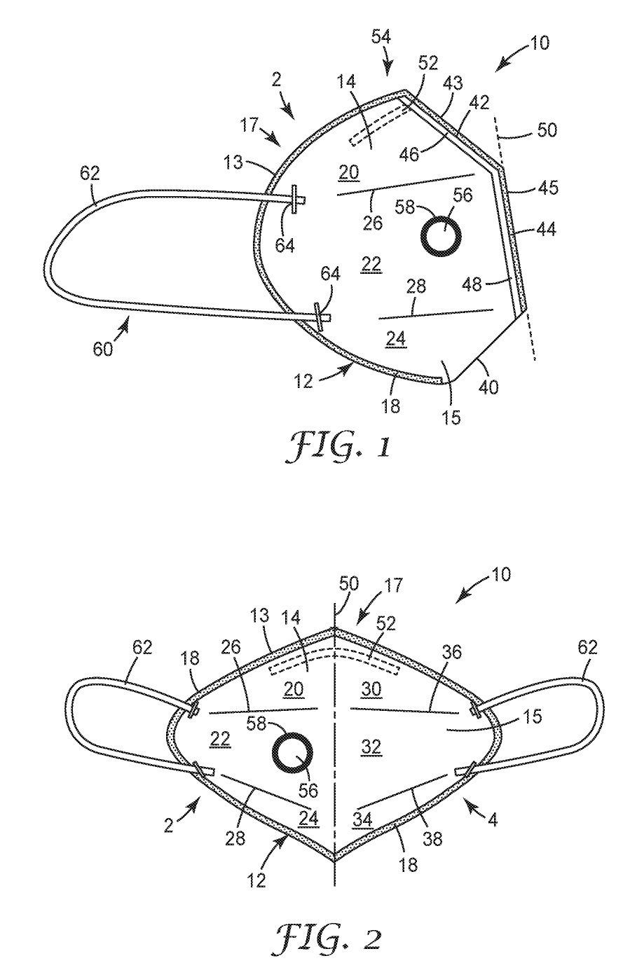

FIGS. 1-4 are various schematic views of one embodiment of a filtering face-piece respirator 10. The respirator 10 includes a mask body 12 having an edge 13. The filtering face-piece respirator 10 can include any suitable respirator, e.g., a flat-fold filtering face-piece respirator, a molded filtering face-piece respirator, etc. In the illustrated embodiment, the respirator 10 is a flat-fold respirator.

The mask body 12 includes a right portion 2 and a left portion 4 (using the terms left, right, upper, and lower in the wearer's sense). The right and left portions 2, 4 are on each side of a centerline 50. The right and left portions 2, 4 are bounded by a perimeter 17 of the mask body 12. The mask body 12 can take any suitable shape or combination of shapes.

The mask body 12 can include any suitable layer or layers. For example, FIG. 4 is a schematic cross-section view of a portion of the mask body 12. The mask body 12 can include an inner cover web 70, outer cover web 72, and filter media 74 disposed between the inner cover web and the outer cover web in a filter region 15 of the mask body (i.e., filter region 15 as shown in FIGS. 1-2). In one or more embodiments, the inner cover web 70 is attached to the outer cover web 72 in a seal region 18. As shown in FIGS. 1-2, the seal region 18 can, in one or more embodiments, extend from the filter region 15 to the edge 13 of the mask body 12 and define the perimeter 17 of the mask body 12. The seal region 18 can include any suitable shape or combination of shapes. The seal region 18 can also include any suitable dimensions. For example, the seal region 18 can have any suitable width. The seal region 18 can extend along any suitable portion of the perimeter 17 of the mask body 12. In one or more embodiments, the seal region 18 can extend along the entire perimeter 17 of the mask body 12, i.e., the seal region defines the entire perimeter of the mask body. In one or more embodiments, the seal region 18 defines at least a portion of the perimeter 17 of the mask body 12.

The seal region 18 can be adapted to contact a face of a wearer. In one or more embodiments, the seal region 18 is adapted to provide a seal against the face of the wearer. Further, in one or more embodiments, a separate seal or gasket can be attached to the seal region 18 and/or the mask body 12 to provide a seal against the face of the wearer.

In one or more embodiments, the filter media 74 can be enclosed between the inner cover web 70 and the outer cover web 72 such that the filter media does not extend to the edge 13 of the mask body 12. In one or more embodiments, the seal region 18 is disposed between the filter media 74 and the edge 13 of the mask body and encloses the filter media between the inner cover web 70 and the outer cover web 72 such that the filter media does not extend to the edge 13. In one or more embodiments, a portion of the filter media 74 can extend into the seal region 18 but not to the edge 13 of the mask body 12. In one or more embodiments, the filter media 74 does not extend into any portion of the seal region 18 such that the seal region does not include the filter media.

Any suitable technique or combination of techniques can be utilized to form the seal region 18. For example, the seal region 18 can be formed using ultrasonic welding, thermal bonding, adhesive attachment, mechanical attachment, and combinations thereof.

The mask body 12 can include any suitable layer or layers, including the filter media 74, the inner cover web 70, and the outer cover web 72. When the respirator 10 is a molded mask, the mask body can also include an optional shaping layer (not shown). See, e.g., U.S. Pat. No. 6,923,182 to Angadjivand et al.; U.S. Pat. No. 7,131,442 to Kronzer et al.; U.S. Pat. Nos. 6,923,182 and 6,041,782 to Angadjivand et al.; U.S. Pat. No. 4,807,619 to Dyrud et al.; and U.S. Pat. No. 4,536,440 to Berg.

In general, the filter region 15 of the mask body 12 removes contaminants from the ambient air and may also act as a barrier layer that precludes liquid splashes from entering the mask interior. The outer cover web 72 can act to stop or slow any liquid splashes, and the filter media 74 may then contain them if there is penetration past the other layers. The filter region 15 of the mask body 12 can include a particle capture or gas and vapor type filter. The filter region 15 may include multiple layers of similar or dissimilar filter media and one or more cover webs as the application requires. In one or more embodiments, the respirator 10 can contain a fluid impermeable mask body that has one or more filter cartridges attached to it. See, e.g., U.S. Pat. No. 6,874,499 to Viner et al.; U.S. Pat. No. 6,277,178 and D613,850 to Holmquist-Brown et al.; RE39,493 to Yuschak et al.; D652,507, D471,627, and D467,656 to Mittelstadt et al.; and D518,571 to Martin.

The inner and outer cover webs 70, 72 may be located on the outer sides of the filtering region 15 to capture any fibers that could come loose therefrom. Typically, the cover webs 70, 72 are made from a selection of fibers that provide a comfortable feel, particularly on a side 71 of the filter region 15 that makes contact with the wearer's face. The constructions of various filter layers, shaping layers, and cover webs that may be used with a mask body used in a respirator 10 are described herein in more detail.

Filter media 74 that may be beneficially employed in the respirator 10 are generally low in pressure drop (e.g., less than about 195 to 295 Pascals at a face velocity of 13.8 centimeters per second) to minimize the breathing work of the mask wearer. Filter media 74 can also be flexible and have sufficient shear strength so that they generally retain their structure under the expected use conditions. Examples of particle capture filters include one or more webs of fine inorganic fibers (such as fiberglass) or polymeric synthetic fibers. Synthetic fiber webs may include electret-charged polymeric microfibers that are produced from processes such as meltblowing. Polyolefin microfibers formed from polypropylene that has been electrically charged can provide utility for particulate capture applications.

In one or more embodiments, the filter media 74 can include one or more filtration layers. Any suitable filtration layer or layers can be included in filter media 74. The filtration layer generally will remove a high percentage of particles and/or or other contaminants from the gaseous stream that passes through it. For fibrous filter layers, the fibers selected depend upon the kind of substance to be filtered and, typically, are chosen so that they do not become bonded together during the manufacturing operation. As indicated, the filtration layer may come in a variety of shapes and forms and typically has a thickness of about 0.2 millimeters (mm) to 1 centimeter (cm), more typically about 0.3 mm to 0.5 cm, and it could be a generally planar web or it could be corrugated to provide an expanded surface area. See, e.g., U.S. Pat. Nos. 5,804,295 and 5,656,368 to Braun et al. The media 74 also may include multiple filtration layers.

Essentially any suitable material that is known (or later developed) for forming a filtration layer may be used as the filtering material. In one or more embodiments, webs of melt-blown fibers, such as those taught in Wente, Van A., Superfine Thermoplastic Fibers, 48 Indus. Eng. Chem., 1342 et seq. (1956), especially when in a persistent electrically charged (electret) form can be utilized (see, e.g., U.S. Pat. No. 4,215,682 to Kubik et al.). These melt-blown fibers may be microfibers that have an effective fiber diameter less than about 20 micrometers (μm) (referred to as BMF for “blown microfiber”), typically about 1 to 12 μm. Effective fiber diameter may be determined according to Davies, C. N., The Separation Of Airborne Dust Particles, Institution Of Mechanical Engineers, London, Proceedings 1B, 1952. In one or more embodiments, the filtration layer can include one or more BMF webs that contain fibers formed from polypropylene, poly(4-methyl-1-pentene), and combinations thereof. Electrically charged fibrillated-film fibers as taught in U.S. patent Re. 31,285 to van Turnhout also may be suitable, as well as rosin-wool fibrous webs and webs of glass fibers or solution-blown, or electrostatically sprayed fibers, especially in microfiber form. Electric charge can be imparted to the fibers by contacting the fibers with water as disclosed in U.S. Pat. No. 6,824,718 to Eitzman et al.; U.S. Pat. No. 6,783,574 to Angadjivand et al.; U.S. Pat. No. 6,743,464 to Insley et al.; U.S. Pat. No. 6,454,986 and U.S. Pat. No. 6,406,657 to Eitzman et al.; and U.S. Pat. No. 6,375,886 and U.S. Pat. No. 5,496,507 to Angadjivand et al. Electric charge also may be imparted to the fibers by corona charging as disclosed in U.S. Pat. No. 4,588,537 to Klasse et al., or by tribocharging as disclosed in U.S. Pat. No. 4,798,850 to Brown. Also, additives can be included in the fibers to enhance the filtration performance of webs produced through the hydro-charging process (see U.S. Pat. No. 5,908,598 to Rousseau et al.). Fluorine atoms, in particular, can be disposed at the surface of the fibers in the filter layer to improve filtration performance in an oily mist environment. See, e.g., U.S. Pat. Nos. 6,398,847 B1, 6,397,458 B1, and 6,409,806 B1 to Jones et al. Typical basis weights for electret BMF filtration layers are about 10 to 100 grams per square meter (g/m²). When electrically charged according to techniques described in, e.g., the '507 Angadjivand et al. patent, and when including fluorine atoms as mentioned in the Jones et al. patents, the basis weight may be about 20 to 40 g/m² and about 10 to 30 g/m², respectively.

In one or more embodiments, the filter media 74 can include a layer that includes sorptive materials such as activated carbon that can be disposed between the fibers and/or various layers that include the filtering structure. Further, separate particulate filtration layers may be used in conjunction with sorptive layers to provide filtration for both particulates and vapors. The sorbent component may be used for removing hazardous or odorous gases from the breathing air. Sorbents may include powders or granules that are bound in a filter layer by adhesives, binders, or fibrous structures. See, e.g., U.S. Pat. No. 6,234,171 to Springett et al. and U.S. Pat. No. 3,971,373 to Braun.

For example, a variety of particles can be employed as sorbents. In one or more embodiments, the particles are capable of absorbing or adsorbing gases, aerosols or liquids expected to be present under the intended service conditions. The particles can be in any useful form including beads, flakes, granules, fibers, or agglomerates. Exemplary particles include activated carbon, alumina and other metal oxides, clay, hopcalite and other catalysts, ion exchange resins, molecular sieves and other zeolites, silica, sodium bicarbonate, biocides, fungicides and virucides. Mixtures of particles can be employed, e.g., to absorb mixtures of gases.

A sorbent layer can be formed by coating a substrate, such as fibrous or reticulated foam, to form a thin coherent layer. Sorbent materials may include activated carbons that are chemically treated or not, porous alumna-silica catalyst substrates, and alumna particles. An example of a sorptive filtering structure that may be conformed into various configurations is described in U.S. Pat. No. 6,391,429 to Senkus et al.

In the embodiment illustrated in FIGS. 1-4, the filter media 74 can include a carbon layer 76. Any suitable number of carbon layers can be included in filter media 74. Any suitable carbon layer or layers can be utilized in filter media 74. In one or more embodiments, the carbon layer 76 can include a nonwoven web that is infiltrated with carbon particles as is described, e.g., in U.S. Patent Publication No. 2006/0254427 to Trend et al.

In one or more embodiments, the filter media 74 can also include one or more particulate filter layers 78, 79. Although filter media 74 is illustrated as including two particulate filter layers 78, 79, the filter media can include any suitable number of particulate filter layers, e.g., 1, 2, 3, 4, 5, or more particulate filter layers. Any suitable particulate filter layer or layers can be utilized in filter media 74, e.g., a filtration layer including a BMF web as described herein. The particulate filter layers 78, 79 can include the same material or combination of materials. In one or more embodiments, the particulate filter layer 78 can include a material or combination of materials different from the material or combination of materials of the particulate filter layer 79. Further, the particulate filter layers 78, 79 can have the same characteristics, e.g., porosity, pressure drop etc. In one or more embodiments, the particulate filter layer 78 can include one or more properties different from one or more properties of the particulate filter layer 79. The carbon layer 76 and the particulate layers 78, 79 can be disposed in any suitable relationship. In one or more embodiments, the carbon layer 76 can be disposed between the particulate filter layers 78, 79.

The layers of the filter media 74 can be attached using any suitable technique or combination of techniques. In one or more embodiments, the layers of the filter media 74 can remain unattached.

The cover webs 70, 72 also may have filtering abilities. One or both of the cover webs 70, 72 may also serve to make the respirator 10 more comfortable to wear. The cover webs may be made from nonwoven fibrous materials such as spun bonded fibers that contain, e.g., polyolefins, and polyesters. See, e.g., U.S. Pat. No. 6,041,782 to Angadjivand et al.; U.S. Pat. No. 4,807,619 to Dyrud et al.; and U.S. Pat. No. 4,536,440 to Berg. When a wearer inhales, air is drawn through the mask body, and airborne particles become trapped in the interstices between the fibers, particularly the fibers in the filter layer.

The inner cover web 70 can be used to provide a smooth surface for contacting the wearer's face. Further, the outer cover web 72, in addition to providing splash fluid protection, can be used for entrapping loose fibers in the mask body and for aesthetic reasons. The outer cover web 72 typically does not provide any substantial filtering benefits to the mask body 12, although it can act as a pre-filter when disposed on the exterior of (or upstream to) the filter media 74. To obtain a suitable degree of comfort, the inner cover web 70 can have a comparatively low basis weight and can be formed from comparatively fine fibers. In one or more embodiments, the inner cover web 70 may be fashioned to have a basis weight of about 5 to 70 g/m² (typically 10 to 30 g/m²), and the fibers may be less than 3.5 denier (typically less than 2 denier, and more typically less than 1 denier but greater than 0.1 denier). Fibers used in the cover webs 70, 72 often have an average fiber diameter of about 5 to 24 micrometers, typically of about 7 to 18 micrometers, and more typically of about 8 to 12 micrometers. The cover web material may have a degree of elasticity (typically, but not necessarily, 100 to 200% at break) and may be plastically deformable.

Suitable materials for the cover webs 70, 72 may be blown microfiber (BMF) materials, e.g., polyolefin BMF materials, e.g., polypropylene BMF materials (including polypropylene blends and also blends of polypropylene and polyethylene). And an exemplary process for producing BMF materials for a cover web is described in U.S. Pat. No. 4,013,816 to Sabee et al. The web may be formed by collecting the fibers on a smooth surface, typically a smooth-surfaced drum or a rotating collector. See, e.g., U.S. Pat. No. 6,492,286 to Berrigan et al. Spun-bond fibers may also be used.

A typical cover web may be made from polypropylene or a polypropylene/polyolefin blend that contains 50 weight percent or more polypropylene. These materials have been found to offer high degrees of softness and comfort to the wearer and also, when the filter material is a polypropylene BMF material, to remain secured to the filter material without requiring an adhesive between the layers. Polyolefin materials that are suitable for use in a cover web may include, for example, a single polypropylene, blends of two polypropylenes, and blends of polypropylene and polyethylene, blends of polypropylene and poly(4-methyl-1-pentene), and/or blends of polypropylene and polybutylene. One example of a fiber for the cover web is a polypropylene BMF made from the polypropylene resin “Escorene 3505G” from Exxon Corporation, providing a basis weight of about 25 g/m² and having a fiber denier in the range 0.2 to 3.1 (with an average, measured over 100 fibers of about 0.8). Another suitable fiber is a polypropylene/polyethylene BMF (produced from a mixture comprising 85% of the resin “Escorene 3505G” and 15 percent of the ethylene/alpha-olefin copolymer “Exact 4023” also from Exxon Corporation) providing a basis weight of about 25 g/m² and having an average fiber denier of about 0.8. Suitable spunbond materials are available under the trade designations “Corosoft Plus 20,” “Corosoft Classic 20” and “Corovin PP S 14,” from Corovin GmbH of Peine, Germany, and a carded polypropylene/viscose material available, under the trade designation “370/15,” from J. W. Suominen O Y of Nakila, Finland. Cover webs typically have very few fibers protruding from the web surface after processing and therefore have a smooth outer surface. Examples of cover webs that may be used in a respirator of the present disclosure are described, e.g., in U.S. Pat. No. 6,041,782 to Angadjivand; U.S. Pat. No. 6,123,077 to Bostock et al.; and PCT Publication No. WO 96/28216A to Bostock et al.

In one or more embodiments, one or both of the inner cover web 70 and outer cover web 72 can include a polymeric netting. Any suitable polymeric netting can be utilized for one or both cover webs. The netting may be made from a variety of polymeric materials. Polymers suitable for netting formation are thermoplastic materials. Examples of thermoplastic polymers that can be used to form polymer netting of the present invention include polyolefins (e.g., polypropylene and polyethylene), polyethylene-vinyl acetate (EVA), polyvinyl chloride, polystyrene, nylons, polyesters (e.g., polyethylene terephthalate), and elastomeric polymers, (e.g., ABA block copolymers, polyurethanes, polyolefin elastomers, polyurethane elastomers, metallocene polyolefin elastomers, polyamide elastomers, ethylene vinyl acetate elastomers, and polyester elastomers). Blends of two or more materials also may be used in the manufacture of nettings. Examples of such blends include polypropylene/EVA and polyethylene/EVA. Polypropylene may be preferred for use in the polymeric netting since melt-blown fibers are regularly made from polypropylene. Use of similar polymers enables proper welding of the support structure to the filtering structure.

The mask body 12 can also include an optional shaping layer(s) (not shown) that may be formed from at least one layer of fibrous material that can be molded to the desired shape with the use of heat and that retains its shape when cooled. Shape retention is typically achieved by causing the fibers to bond to each other at points of contact between them, for example, by fusion or welding. Any suitable material known for making a shape-retaining layer of a direct-molded respiratory mask may be used to form the mask shell, including, for example, a mixture of synthetic staple fiber, e.g., crimped, and bicomponent staple fiber. Bicomponent fiber is a fiber that includes two or more distinct regions of fibrous material, typically distinct regions of polymeric materials. Typical bicomponent fibers include a binder component and a structural component. The binder component allows the fibers of the shape-retaining shell to be bonded together at fiber intersection points when heated and cooled. During heating, the binder component flows into contact with adjacent fibers. The shape-retaining layer can be prepared from fiber mixtures that include staple fiber and bicomponent fiber in weight-percent ratios that may range, for example, from 0/100 to 75/25. In one or more embodiments, the material includes at least 50 weight-percent bicomponent fiber to create a greater number of intersection bonding points, which, in turn, increase the resilience and shape retention of the shell.

Suitable bicomponent fibers that may be used in the shaping layer include, for example, side-by-side configurations, concentric sheath-core configurations, and elliptical sheath-core configurations. One suitable bicomponent fiber is the polyester bicomponent fiber available, under the trade designation “KOSA T254” (12 denier, length 38 mm), from Kosa of Charlotte, N.C., U.S.A., which may be used in combination with a polyester staple fiber, for example, that is available from Kosa under the trade designation “T259” (3 denier, length 38 mm) and possibly also a polyethylene terephthalate (PET) fiber, for example, that available from Kosa under the trade designation “T295” (15 denier, length 32 mm). In one or more embodiments, the bicomponent fiber may include a generally concentric sheath-core configuration having a core of crystalline PET surrounded by a sheath of a polymer formed from isophthalate and terephthalate ester monomers. The latter polymer is heat softenable at a temperature lower than the core material. Polyester has advantages in that it can contribute to mask resiliency and can absorb less moisture than other fibers.

In one or more embodiments, the optional shaping layer can be prepared without bicomponent fibers. For example, fibers of a heat-flowable polyester can be included together with, e.g., stapled, crimped, fibers in a shaping layer so that, upon heating of the web material, the binder fibers can melt and flow to a fiber intersection point where it forms a mass that upon cooling of the binder material, creates a bond at the intersection point. Staple fibers (for the shaping component) that are pre-treated with Ammonium Polyphosphate-type intumescent FR agents may be used in connection with the present disclosure in addition to or in lieu of a spray-application of the agent. Having the staple fibers contain, or, otherwise being treated with, the agent and then formed into a shell (using binder fibers to hold it together) would be another pathway to employ the agents.

When a fibrous web is used as the material for the shape-retaining shell, the web can be conveniently prepared on a “Rando Webber” air-laying machine (available from Rando Machine Corporation, Macedon, N.Y.) or a carding machine. The web can be formed from bicomponent fibers or other fibers in conventional staple lengths suitable for such equipment. To obtain a shape-retaining layer that has the required resiliency and shape-retention, the layer can have a basis weight of at least about 100 g/m², although lower basis weights are possible. Higher basis weights, for example, approximately 150 or more than 200 g/m², may provide greater resistance to deformation and greater resiliency and may be more suitable if the mask body is used to support an exhalation valve. Together with these minimum basis weights, the shaping layer typically has a maximum density of about 0.2 g/cm² over the central area of the mask. Typically, the shaping layer would have a thickness of about 0.3 to 2.0, more typically about 0.4 to 0.8 millimeters. Examples of shaping layers suitable for use in the present disclosure are described, e.g., U.S. Pat. No. 5,307,796 to Kronzer et al.; U.S. Pat. No. 4,807,619 to Dyrud et al.; and 4,536,440 to Berg. Staple fibers (for the shaping component) that are pre-treated with Ammonium Polyphosphate-type intumescent FR agents may be used in connection with the present disclosure in addition to or in lieu of a spray-application of the agent. Having the staple fibers contain, or, otherwise being treated with, the agent and then formed into a shell (using binder fibers to hold it together) would be another pathway to employ the agents.

The mask body 12 of the respirator 10 can also include one or more panels that can be separated by one or more lines of demarcation. For example, as shown in FIG. 2, which is a front schematic view of an exterior surface 14 of the respirator 10 in an open ready-to-use configuration, the mask body 12 of respirator 10 includes six filtration panels. Three of those panels are shown in FIG. 1 as right upper panel 20, right central panel 22, and right lower panel 24 of the right portion 2 of the mask body. The remaining three panels are shown in FIG. 2 as left upper panel 30, left central panel 32, and left lower panel 34 of the left portion 4 of the mask body 12. Vertical bisecting line or centerline 50 divides the left and right portions 2, 4 of respirator 10.

In one or more embodiments, upper right and left panels 20, 30 are connected through a second seal region 42, central panels 22, 32, are connected through a third seal region 44, and lower panels 24, 34 are connected through a vertical fold 40. As a result, the respirator 10 can be considered a vertical chin-fold respirator. In one or more embodiments, the respirator 10 can include a vertical fold line in place of the third seal region 44 that connects the right and left central panels 22, 32 such that the respirator can be considered to be a central fold respirator. In such embodiments, the right and left lower panels 24, 34 can be connected through an additional seal region. Further, in one or more embodiments, the second seal region 42 can be replaced with a fold line such that the respirator can be considered a nose fold respirator. In such embodiments, the right and left lower panels 24, 34 can be connected through an additional seal region.

In one or more embodiments, the inner cover web 70 is attached to the outer cover web 72 between upper panels 20, 30 in the second seal region 42. In one or more embodiments, the filter media 74 does not extend into at least a portion of the second seal region 42. In one or more embodiments, no portion of the filter media 74 extends into the second seal region 42 such that the second seal region does not include filter media. In one or more embodiments, a portion of the filter media 74 extends into the second seal region 42 but not to an edge 43 of the second seal region. The filter media 74 in the upper panels 20, 30 is, therefore, enclosed between the inner cover web 70 and the outer cover web 72 such that the filter media 74 does not extend to the edge 43. Any suitable technique or combination of techniques can be utilized to form the second seal region 42, e.g., the same techniques used to form seal region 18.

In one or more embodiments, the inner cover web 70 is attached to the outer cover web 72 between central panels 22, 32 in the third seal region 44. In one or more embodiments, the filter media 74 does not extend into at least a portion of the third seal region 44. In one or more embodiments, no portion of the filter media 74 extends into the third seal region 44 such that the third seal region does not include filter media. In one or more embodiments, a portion of the filter media 74 extends into the third seal region 44 but not to an edge 45 of the third seal region. The filter media 74 in the central panels 22, 32 is, therefore, enclosed between the inner cover web 70 and the outer cover web 72 such that the filter media does not extend to the edge 45. Any suitable technique or combination of techniques can be utilized to form the third seal region 44, e.g., the same techniques used to form seal region 18.

In one or more embodiments, the right upper panel 20 and right central panel 22 are separated by a first line of demarcation 26, and the right central panel 22 and the right lower panel 24 are separated by a second line of demarcation 28. Similarly, in one or more embodiments, the left upper panel 30 and the left central panel 32 are separated by a first line of demarcation 36, and the left central panel 32 and the left lower panel 34 and separated by a second line of demarcation 38. The first and second lines of demarcation of each of the right and left portions 2, 4 of the mask body 12 can include any suitable bond line, weld line, seam, etc. Further, the first and second lines of demarcation for each of the right and left portions 2, 4 of the mask body 12 can be formed using any suitable technique or combination of techniques.

For example, panels 20 and 22 are connected through welded bond line 26, which extends over at least part of the region between panels 20 and 22. In similar fashion, panels 22 and 24 are connected through welded bond line 28, panels 30 and 32 are connected through welded bond line 36 and panels 32 and 34 are connected through welded bond line 38. One or more of panels 20, 22, 24, 30, 32, and 34 may be provided as separate components. Further, respirator 10 may be folded in half (e.g., for storage in a package prior to use or in a wearer's pocket) along the centerline 50 that, in this embodiment, corresponds to third seal region 44.

The mask body 12 can include an additional weld line 48 between the central panels 22, 32. The additional weld line 48 can connect the inner cover web 70, filter media 74, and outer cover web 72 of the right central panel 22 and the inner cover web, filter media, and outer cover web of the left central panel 32. The weld line 48 can be positioned in any suitable location. In one or more embodiments the weld line 48 can be disposed adjacent the third seal region 44. As used herein, the phrase “adjacent the third seal region 44” means that the weld line 48 is disposed closer to the third seal region 44 than to the second seal region 42. The weld line 48 can also have any suitable dimensions and take any suitable shape. Further, the weld line 48 can be formed using any suitable technique or combination of techniques. In one or more embodiments, the additional weld line 48 can provide added structural integrity to the third seal region 44 such that the upper panels 20, 30 remain attached when the respirator is opened in a cup-like configuration as shown in FIG. 2.

Further, the mask body 12 can include another additional weld line 46 between upper panels 20, 30. Weld line 46 can connect the inner cover web 70, filter media 74, and outer cover web 72 of the right upper panel 20 to the inner cover web, filter media, and outer cover web of the left upper panel 30. The weld line 46 can be positioned in any suitable location. In one or more embodiments the weld line 46 can be disposed adjacent the second seal region 42. As used herein, the phrase “adjacent the second seal region 44” means that the weld line 46 is disposed closer to the second seal region 42 than to the third seal region 44. The weld line 46 can also have any suitable dimensions and take any suitable shape. Further, the weld line 46 can be formed using any suitable technique or combination of techniques. Weld line 46 can provide added structural integrity to the second seal region 42 such that the top panels 20, 30 remain attached when the respirator 10 is opened in a cup-like configuration.

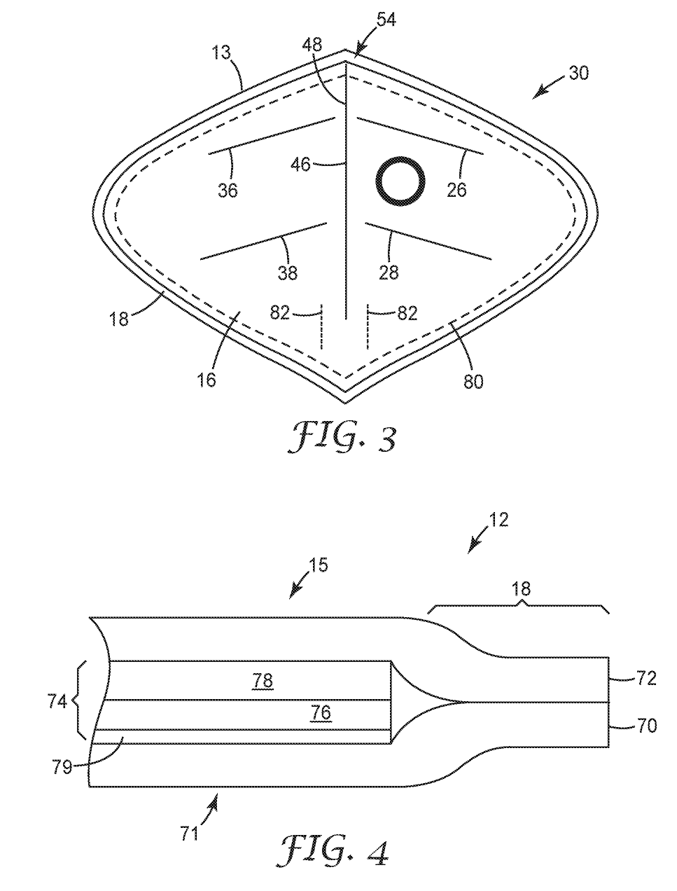

In one or more embodiments, the filter media 74 can be attached to one or both of the inner cover web 70 and outer cover web 72. For example, as shown in FIG. 3, which is a schematic rear view of an inner surface 16 of the respirator 10, a weld line 80 can be formed to attach the inner cover web 70 to the filter media 74. The weld line 80 can be formed such that the seal region 18 is between the weld line 80 and the edge 13 of the mask body 12. The weld line 80 can have any suitable length and thickness. For example, the weld line 80 can be formed in any portion of the mask body 12, e.g., in one or both of the right and left portions 2, 4 of the mask body. In one or more embodiments, the weld line 80 can be continuous. In one or more embodiments, the weld line 80 can be discontinuous, e.g., point welds. The weld line 80 can take any suitable shape or combination of shapes.

Further, in one or more embodiments, additional weld lines 82 can be formed that attach the inner cover web 70 to the filter media 74. The additional weld lines 82 can have characteristics similar to those of weld line 80. The weld lines 80, 82 can help prevent the filter media 74 from shifting in relation to the inner cover web 70 and the outer cover web 72 during manufacture or when the completed mask is in use. Any suitable technique or combination of techniques can be utilized to attach the filter media 74 to one or both of the inner cover web 70 and the outer cover web 72.

In one or more embodiments, the respirator 10 can include a harness 60. The harness 60 can include any suitable harnesses. In the embodiment illustrated in FIGS. 1-4, the harness 60 includes ear loops 62 that are attached to the mask body 12 at attachment points 64. In general, the strap(s) that are used in the respirator harness can be expanded to greater than twice its total length and can be returned to its relaxed state many times throughout the useful life of the respirator. The strap also could possibly be increased to three or four times its relaxed state length and can be returned to its original condition without any damage thereto when the tensile forces are removed. In one or more embodiments, the elastic limit thus is not less than two, three, or four times the relaxed-state length of the strap(s). Typically, the strap(s) are about 20 to 32 cm long, 3 to 20 mm wide, and about 0.3 to 1 mm thick. The strap(s) may extend from the first side of the respirator to the second side as a continuous strap, or the strap may have a plurality of parts, which can be joined together by further fasteners or buckles. For example, the strap may have first and second parts that are joined together by a fastener that can be quickly uncoupled by the wearer when removing the mask body from the face. In one or more embodiments, the strap may form a loop that is placed around the wearer's ears. See, e.g., U.S. Pat. No. 6,394,090 to Chen et al. Examples of fastening or clasping mechanisms that may be used to join one or more parts of the strap together are shown, e.g., in U.S. Pat. No. 6,062,221 to Brostrom et al. and U.S. Pat. No. 5,237,986 to Seppala et al.; and in EP Patent Publication No. 1,495,785A1 to Chien. The harness may also include a reusable carriage, one or more buckles, and/or a crown member to support the respirator on a person's head. See, e.g., U.S. Pat. Nos. 6,732,733 and 6,457,473 to Brostrom et al.; and U.S. Pat. No. 6,591,837 and U.S. Pat. No. 6,715,490 to Byram.

Although a filtering face-piece respirator has been illustrated in the present disclosure, the respirator may include a compliable rubber-type mask that has one or more filter cartridges attached to it. See, e.g., U.S. Pat. No. RE 39,493 to Yuschak et al. and U.S. Pat. No. 7,650,884 to Flannigan et al. Or it could be a full face respirator. See, e.g., U.S. Pat. No. 8,067,110 to Rakow et al.; U.S. Pat. No. 7,594,510 to Betz et al.; and D421,118 and D378,610 to Reischel et al.

In one or more embodiments, an exhalation valve (not shown) may be attached to the mask body 12 to facilitate purging exhaled air from the interior gas space. The use of an exhalation valve may improve wearer comfort by rapidly removing the warm moist exhaled air from the mask interior. See, e.g., U.S. Pat. Nos. 7,188,622; 7,028,689, and 7,013,895 to Martin et al.; U.S. Pat. Nos. 7,428,903; 7,311,104; 7,117,868; 6,854,463; 6,843,248; and U.S. Pat. No. 5,325,892 to Japuntich et al.; U.S. Pat. No. 7,302,951 and U.S. Pat. No. 6,883,518 to Mittelstadt et al.; and RE 37,974 to Bowers. Essentially any exhalation valve that provides a suitable pressure drop and that can be properly secured to the mask body 12 may be used in connection with the present disclosure to rapidly deliver exhaled air from the interior gas space to the exterior gas space.

As illustrated in FIGS. 1-3, a valve opening 56 that is adapted to receive an exhalation valve can be formed in any suitable location through the mask body 12. Although shown as being formed in right central panel 22, the valve opening 56 can be formed, e.g., in the left central panel 32, the right or left upper panels 20, 30, or the right or left lower panels 24, 34. Further, any suitable number of valve openings can be formed through the mask body 12 to accommodate any suitable number of exhalation valves.

In one or more embodiments, a seal region 58 can be formed around at least a portion of the valve opening 56 such that the filter media 74 is enclosed between the inner cover web 70 and the outer cover web 72, and the filter media does not extend to an edge of the opening 56. The seal region 58 can completely enclose the valve opening 56. In one or more embodiments, the filter media 74 does not extend into at least a portion of the seal region 58. In one or more embodiments, the filter media 74 does not extend into any portion of the seal region 58. Further, in one or more embodiments, the seal region 58 can prevent particles of the filter media 74 from becoming lodged in the exhalation valve. Such particles can prevent the valve from achieving a complete seal when a user inhales air through the mask body 12, thereby potentially reducing the effectiveness of the respirator 10.

Further, in one or more embodiments, the mask body 12 can include a nose clip 52 (as shown in FIGS. 1-2). Any suitable nose clip 52 can be utilized. In one or more embodiments, the nose clip 52 may be essentially any additional part that assists in improving the fit over the wearer's nose. Because the wearer's face exhibits a major change in contour in the nose region, a nose clip may be used to better assist in achieving the appropriate fit in this location. The nose clip may include, for example, a pliable dead soft band of metal such as aluminum, which can be shaped to hold the mask in a desired fitting relationship over the nose of the wearer and where the nose meets the cheek. The nose clip may be linear in shape when viewed from a plane projected onto the mask body when in its folded or partially folded condition. In one or more embodiments, the nose clip can be an M-shaped nose clip, an example of which is shown in U.S. Pat. No. 5,558,089 and Des. 412,573 to Castiglione. Other exemplary nose clips are described in U.S. Pat. No. 8,066,006 to Daugaard et al.; U.S. Pat. No. 8,171,933 to Xue et al.; and U.S. Patent Publication No. 2007-0068529A1 to Kalatoor et al.

The nose clip 52 can be disposed adjacent a nose region 54 of the mask body 12. The nose clip 52 can be disposed on an outer most surface (i.e., exterior surface 14) of the mask body 12, e.g., on an outer cover web of the filtering structure of the mask body 12. The nose clip 52 can be disposed on the outermost surface 14 using any suitable technique or combination of techniques. For example, the nose clip 52 can be attached to the outermost surface 14 using, e.g., adhesives, etc. In one or more embodiments, the nose clip 52 can be disposed between an outer cover web and an interior layer, e.g., the filter media 74. The nose clip 52 can be disposed between the outer cover web and the filtration layer using any suitable technique or combination of techniques, e.g., welding the outer cover web to the filtration layer in a pattern adjacent the nose clip such that the nose clip is secured in place between the outer cover web and the filtration layer.

Further, in one or more embodiments, a portion (not shown) of the mask body 12 can be folded over upon itself in a nose region 54 of the mask body to form a fold that intersects the centerline 50. The portion of the mask body 12 that is folded over can be attached to the interior surface 16 of the mask body 12. In one or more embodiments, the portion of the mask body 12 can be folded over onto the exterior surface 15 of the mask body 12. The portion of the mask body 12 that is folded over can be attached to the mask body using any suitable technique or combination of techniques, e.g., welding, adhering, fastening, etc. For example, an edge of the folded portion can be attached to the mask body 12, e.g., by welding the edge to the mask body. In one or more embodiments, the folded-over portion can provide a cushion between the nose clip 52 and the wearer's face as is described, e.g., in U.S. Patent Publication No. 2011/0315144 to Eitzman et al. The folded portion can be used instead of or in addition to a nose foam and can provide additional comfort to a wearer while providing a snug fit over the nose.

The various embodiments of respirators described herein can be manufactured using any suitable technique or combination of techniques. See, e.g., U.S. Pat. No. 6,148,817 to Bryant et al.; U.S. Pat. No. 6,722,366 to Bostock et al.; U.S. Pat. No. 6,394,090 to Chen et al., and U.S. Patent Publication No. 2008/0011303 to Angadjivand et al. In one or more embodiments, the process can be continuous, i.e., the respirator can be manufactured along a manufacturing line without the need to remove the respirator from the line prior to the completion of the process. Although the process is described in reference to the respirator 10 as illustrated in FIGS. 1-4, the process can be utilized to manufacture any flat-fold respirator.

The respirator 10 can be formed from a single piece, although multiple pieces can be attached to one another using any suitable technique or combination of techniques, such as a batch process (e.g., by plunge welding) or a continuous process (e.g., rotary welding). In either process, the filter media 74 can be formed and then cut to form a filter media blank. In one or more embodiments, the filter media blank can then be attached to the inner cover web 70. Any suitable technique or combination of techniques can be utilized to cut and attach the filter media blank to the inner cover web 70. In one or more embodiments, the filter media blank can be formed such that a border region exists between an edge of the filter media blank and an edge of the inner cover web 72 when the two are attached such that the seal region 18 can be formed when the outer cover web is attached to the inner cover web. The outer cover web 72 can be attached to the inner cover web 70 to form a mask body blank. The blank can be trimmed to form the outer forming edges. Other techniques may be employed for forming the edges, such as ultrasonic welding, stitching, and the application of pressure to form the edges (with or without the addition of heat).

A foam portion can optionally be positioned between the inner cover web 70 and the filter media 74. In one or more embodiments, the foam portion and/or nose clip 52 may be positioned on an outer surface of either the inner cover web 70 or the outer cover web 72. A reinforcing material is optionally positioned proximate a center on the filter media 74. The nose clip 52 is optionally positioned along one edge of the filter media 74 proximate the reinforcing material at a nose clip application station. In one or more embodiments, the nose clip 52 is disposed on the outer cover web 72 or filter media 74 adjacent an upper perimeter segment. The filter media 74, reinforcing material, and nose clip 52 are covered by the outer cover web 72 to form a web assembly. The web assembly may be held together by surface forces, electrostatic forces, thermal bonding, or an adhesive.

An exhalation valve is optionally inserted into the web assembly at a valving station. The valving station can form a hole proximate the center of the web assembly. The edges of the hole may be sealed to form seal region 58. The valve may be retained in the hole by welding, adhesive, pressure fit, clamping, snap assemblies or some other suitable means.

In one or more embodiments, the inner cover web 70 is attached to the outer cover web 72 to form the seal region 18 that defines the perimeter of the mask body 12. The filter media 74 is disposed between the inner cover web 70 and the outer cover web 72 to provide the mask body 12. In one or more embodiments, the filter media 74 does not extend into at least a portion of the seal region 18. The mask body 12 can be trimmed along a perimeter (e.g., perimeter 17 of respirator 10) at a face fit station. Other welds or bond lines can be formed at the face fit station, e.g., first lines of demarcation 26, 36, second lines of demarcation 28, 38, additional weld lines 80, 82, and welds formed by welding the portion of the mask body 12 that is folded over on itself. Any suitable technique or combination of techniques can be utilized to form these and other welds on the mask body 12.

Strap material forming ear loops 62 or headbands can be positioned on the mask body 12 and attached to the mask body 12 at attachment locations 64.

At a folding station, the mask body 12 is folded along vertical fold line 50 (as shown in FIG. 1), and the right and left upper panels 20, 30 are connected by attaching the inner cover web 70 and outer cover web 72 to form the second seal region 42. And in one or more embodiments, the right and left central panels 22, 32 can be connected by attaching the inner cover web 70 and the outer cover web 72 to form the third seal region 44. The second and third seal regions 42, 44 can be formed using any suitable technique or combination of techniques.

In one or more embodiments, the inner cover web 70, filter media 74, and the outer cover web 72 in the central panel 22 of the right portion 2 can be connected to the inner cover web, the filter media, and the outer cover web in the central panel 32 of the left portion 4 by the weld line 48 at the folding station or an addition welding station. The weld line 48 can be formed using any suitable technique or combination of techniques. Further, in one or more embodiments, the inner cover web 70, filter media 74, and the outer cover web 72 in the upper panel 20 of the right portion 2 can be connected to the inner cover web, the filter media, and the outer cover web in the upper panel 30 of the left portion 4 by the weld line 46 at the folding station or an addition welding station. The weld line 46 can be formed using any suitable technique or combination of techniques.

All references and publications cited herein are expressly incorporated herein by reference in their entirety into this disclosure, except to the extent they may directly contradict this disclosure. Illustrative embodiments of this disclosure are discussed and reference has been made to possible variations within the scope of this disclosure. These and other variations and modifications in the disclosure will be apparent to those skilled in the art without departing from the scope of the disclosure, and it should be understood that this disclosure is not limited to the illustrative embodiments set forth herein. Accordingly, the disclosure is to be limited only by the claims provided below.

1. A filtering face-piece respirator comprising a mask body, wherein the mask body comprises:
an inner cover web;
an outer cover web;
filter media disposed between the inner cover web and outer cover web in a filter region of the mask body; and
a seal region that defines at least a portion of a perimeter of the mask body, wherein the inner cover web is attached to the outer cover web in the seal region, and further wherein the filter media does not extend into at least a portion of the seal region.

2. The respirator of claim 1, further comprising a harness attached to the mask body.

3. The respirator of claim 1, wherein the mask body further comprises right and left portions on each side of a centerline, wherein the right and left portions are bounded by the perimeter of the mask body.

4. The respirator of claim 3, wherein each of the right and left portions of the mask body comprises an upper panel, a central panel, and a lower panel, wherein the upper panel and central panel are separated by a first line of demarcation, and further wherein the central panel and the lower panel are separated by a second line of demarcation.

5. The respirator of claim 4, wherein each of the first and second lines of demarcation comprises a weld line.

6. The respirator of claim 4, wherein the lower panel of the right portion and the lower panel of the left portion are connected through a vertical fold.

7. The respirator of claim 4, wherein the upper panel of the right portion and the upper panel of the left portion are connected through a second seal region, wherein the filter media does not extend into at least a portion of the second seal region.

8. The respirator of claim 7, wherein the central panel of the right portion and the central panel of the left portion are connected through a third seal region, wherein the filter media does not extend into at least a portion of the third seal region.

9. The respirator of claim 7, wherein the inner cover web, filter media, and outer cover web in the central panel of the right portion are connected to the inner cover web, filter media, and outer cover web in the central panel of the left portion by a weld line adjacent the third seal region.

10. The respirator of claim 9, wherein the inner cover web, filter media, and outer cover web in the upper panel of the right portion are connected to the inner cover, filter media, and outer cover web in the upper panel of the left portion by a weld line adjacent the second seal region.

11. The respirator of claim 1, wherein the filter media comprises a carbon layer.

12. The respirator of claim 11, wherein the carbon layer comprises a nonwoven web and carbon particles enmeshed in the web.

13. The respirator of claim 11, wherein the filter media further comprises a blown microfiber web layer.

14. The respirator of claim 1, wherein the filter media is attached to the inner cover web along a weld line adjacent the seal region.

15. The respirator of claim 1, wherein the mask body is molded into a cup-shaped configuration.

16. A filtering face-piece respirator comprising a mask body, wherein the mask body comprises:
an inner cover web;
an outer cover web; and
filter media enclosed between the inner cover web and outer cover web such that the filter media does not extend to an edge of the mask body.

17. The respirator of claim 16, wherein the filter media is attached to at least one of the inner cover web and the outer cover web.

18. The respirator of claim 17, wherein the inner cover web is attached to the outer cover web along the edge of the mask body.

19. The respirator of claim 18, wherein the filter media comprises a carbon layer comprising a nonwoven web and carbon particles enmeshed in the nonwoven web.

20.
forming filter media;
attaching the filter media to an inner cover web; and
attaching the inner cover web to an outer cover web to form a seal region that defines a perimeter of the mask body, wherein the filter media is disposed between the inner cover web and the outer cover web, and further wherein the filter media does not extend into at least a portion of the seal region.
